(19) United States
(12) Patent Application Publication
(10) Pub. No.: US 2026/0267063 A1
(43) Pub. Date: Sep. 10, 2026

(54) OPTICAL MONOLITHICALLY INTEGRATED DEVICES

(71) Applicant: ElectroPhotonic-IC Inc., Kanata (CA)

(72) Inventors: Lawrence E. TAROF, Kanata (CA); Anton MENSHOV, Montreal (CA); Vighen PACRADOUNI, Montreal (CA); Joshua BAXTER, Kanata (CA); Derek NAM, Redwood City, CA (US); Dhiraj KUMAR, Redondo Beach, CA (US)

(21) Appl. No.: 19/555,296

(22) Filed: Mar. 3, 2026

Related U.S. Application Data
(60) Provisional application No. 63/766,464, filed on Mar. 4, 2025.

(51) Int. Cl. G02B 6/12

(52) U.S. Cl. CPC G02B 6/12007; G02B 2006/12078; G02B 2006/12085; G02B 2006/12123; G02B 2006/12126; G02B 2006/12128; G02B 2006/12142; G02B 2006/12164

(57) ABSTRACT

An optical receiver comprises monolithically integrated components comprising a demultiplexer (DEMUX), a plurality of waveguide photodiodes (WG-PD) and a plurality of transimpedance amplifiers (TIA). Each TIA comprises InP heterojunction bipolar transistors (HBT) fabricated from a first plurality of layers of an epitaxial layer stack grown on a SI: InP substrate; each WG-PD is fabricated from a second plurality of layers of the epitaxial layer stack, overlying the first plurality of layers. The DEMUX is fabricated from photonics layers of the epitaxial stack; outputs of the DEMUX may be laterally or vertically coupled to each WG-PD. This design approach enables cost-effective fabrication of a monolithically integrated DEMUX with multiple PIN-TIAs for DWM applications. Also disclosed in an optical transmitter wherein a plurality of electro-absorption modulators (EAM), EAM Drivers, and a Multiplexer (MUX) are monolithically integrated for WDM applications.

### CROSS-REFERENCE TO RELATED APPLICATIONS

This application is related to and claims the benefit of United States provisional patent application no. 63/766,464 filed Mar. 4, 2025, entitled “Optical monolithically integrated devices”, which is incorporated herein by reference in its entirety.

This application is related to United States patent application 17/785,989, which is a National Stage entry of PCT International Application no. PCT/CA2020/051666, filed Dec. 4, 2020, designating the United States and having a §371(c)(1) date of Jun. 16, 2022, and which claims the benefit of United States provisional patent application no. 62/950,479 filed Dec. 19, 2019; United States patent application 18/973,578 filed Dec. 9, 2024; both entitled “Optical Receiver Comprising Monolithically Integrated Photodiode and Transimpedance Amplifier”, all of which are incorporated by reference in their entirety.

This application is related to United States patent application no. 19/544,235 filed Feb. 10, 2026, entitled “A compact electro-optical device for changing a signal”, which claims the benefit of United States provisional patent application no.63/820,879, filed Jun. 10, 2025, entitled “A compact electro-optical device for modulating a signal”, which are incorporated herein by reference in their entirety.

This application is related to United States patent application no. 19/259,200, filed Jul. 3, 2025, which claims the benefit of United States provisional patent application no. US63/809,670, filed May 21, 2025, entitled “Methods And Systems For High-Speed Optical Applications, And The Design Of A Corresponding Receiver And Transmitter”, which is incorporated herein by reference in its entirety.

This application is related to United States patent application no. 19/089,534, filed Mar. 25, 2025, entitled “Vertically Integrated Electro-absorption Modulated Laser”, which is a continuation-in-part of United States patent application no. 17/687, 803, filed Mar. 7, 2022, entitled “Vertically integrated Electro-absorption Modulated Laser”, which are incorporated herein by reference in their entirety.

This application is related to United States patent application no. 18/984,180, filed Dec. 17, 2024, entitled “Vertically Integrated Electro-absorption Modulated Laser”, which is a continuation of United States patent application no. 17/687, 803, filed Mar. 7, 2022, entitled “Vertically Integrated Electro-absorption Modulated Laser” which are incorporated herein by reference in their entirety.

This application is related to United States patent application 19/374,354, filed Jun. 10, 2025 and entitled “EAM structures for optical receivers and transmitters” and which claims the benefit of United States provisional patent application 63/820,920, filed Oct. 30, 2025, entitled “Pin Photodiode Device Structures For Optical Receivers And Transmitters”, which are incorporated by reference in their entirety.

This application is related to United States patent application no. 19/544,484 filed Feb. 19, 2026, , entitled “An optical communication device made according to an Artificial Intelligence-based inverse design process” which is incorporated herein by reference in its entirety.

### TECHNICAL FIELD

The present application relates to optical monolithically integrated devices for applications such as high-speed data interconnect, 5G wireless communications, and gigabit-capable passive optical networks (GPON). The devices such as a receiver or a transmitter may include a waveguide e.g. a photodiode detector (PD); electronics e.g. a transimpedance amplifier (TIA), and other devices as required.

### BACKGROUND

A passive optical network (PON) is a point-to-multipoint, fiber to the premises network architecture. PON networks use passive splitters and combiners to distribute optical signals, without requiring active elements such as optical amplifiers. An optical line terminal (OLT) at the central office of the service provider communicates with optical network units (ONUs) at each customer premises. The OLT produces an optical signal from electrical signals for transmission along an optical transmission line towards the receiver end ONUs. Each ONU comprises an optical receiver for converting the received optical signal to an electrical output.

For example, 10Gigabit-capable PON may be referred to as 10G-PON or XG-PON. Recommendation ITU-T G.987 is a family of documents that define this access network standard. Simultaneous upstream and downstream transmission over the same fiber is made possible through wavelength division multiplexing (WDM). This technology allows one PON wavelength transmission for upstream and another for downstream. For example, 10G-PON uses 1577nm for downstream and 1270nm for upstream.

Passive optical networks are becoming more sought after and used in most situations in the modern world. As with all developing technologies there is a drive for smaller, faster and other related improvements for such networks. As a result, single chip integrated devices are a requirement, and technologies are developing and combining to provide solutions to this technical challenge.

The optical receiver of the ONU and the transmission end devices comprises multiple devices, including a photodiode detector and a transimpedance amplifier. The optical performance of such a device is dependent on several factors, e.g.:

Photo-diode optical and electrical performance such as responsivity, carrier transit time, and RC electrical characteristics.

Transimpedance amplifier semiconductor performance such as gain, noise, overload and bandwidth.

Hybrid integration parasitics and packaging parasitics, such as series input inductance and stray capacitance. Hybrid integration parasitics and packaging parasitics, such as series input inductance and stray capacitance; and

The nature and location of any additional devices included in the module making up the device.

For 10G PON, optical receivers for 1577nm have typically used a hybrid arrangement of an avalanche photodiode (APD) and a transimpedance amplifier (TIA), i.e. discrete components. Recently monolithic approaches have been proposed in for example United States patent application 17/785,989 and United States patent application 18/973,578 hereby incorporated by reference.

At present, commercially available semiconductor lasers emitting in the 1577nm wavelength range have limited output power and InGaAs pin photodiodes (PIN PD or PIN) do not have sufficient sensitivity to be used as ONU optical detectors for 1577nm (1575-1581nm). The use of more expensive APDs to obtain the required performance, e.g. responsivity and sensitivity has been used but still has disadvantages. Apart from higher cost, other drawbacks of APD are the need for a high voltage supply, extra circuitry for the control loop, poor reliability at longer lifetimes, or limited operational lifetime.

There are many other applications in which optical signals are used and some of these applications need to be distributed between transmitters and receivers via an appropriate network. Some applications such as PON may use a specific wavelength for uplink transmissions and a different wavelength for downlink transmission. Some applications use wavelength division multiplexing (WDM) comprising optical signals of multiple wavelengths which are multiplexed onto a single optical fiber, for example, using multiple wavelengths in the O-band, L-band and C-band wavelength ranges. WDM networks include e.g. high-speed optical data interconnects for data centers, which may be short range optical interconnects within a data center, or longer-range optical interconnects between data centers, 5G network optical communications and other similar forms of transmission and reception techniques.

As technology advances there is a need to combine further and different devices beyond photodiodes and TIAs. This adds additional complexity and requires different consideration in terms of positioning and locating the different devices to optimize space and performance on a monolithic substrate. Other devices may be included in both the receiver and transmitters alike. To achieve this is a challenge if speed of operation and size of the device continues to be pushed beyond current norms, e.g. next generation high-speed modulation schemes 112GB, 224Gb/s PAM4 modulation and 224GB, 448Gb/s PAM4 modulation applications.

The photodiode technology sets the physical limit on sensitivity and bandwidth performance in the receiver and transmitter. The choice of TIA technology and design approach strongly determines the overall device performance. The nature of the devices included in the receiver and transmitter define limits in terms of size and speed of operation. For WDM applications, currently available multiplexers and demultiplexers based on conventional waveguide structures are relatively large devices, and take up a considerable area on chip, e.g. >500µm x 500µm for a 4-channel demultiplexer. For other sized multiplexers the size may be considerable larger.

One area of development that offers an option for the design of new devices to address the varying challenges is the use of Artificial-Intelligence (AI)-based inverse design techniques. These use AI to design a layout for pixelated material in for example silicon and silicon oxide to generate a photonic device has been proposed. For example, a 4-channel coarse wavelength division multiplexing demultiplexer has been suggested in A. K. C. Cheung et al., "Inverse-designed CWDM demultiplexer operated in O-band," 2024 Optical Fiber Communications Conference and Exhibition (OFC), San Diego, CA, USA, 2024, pp. 1-3. This is a specific example and there remain many challenges in the ability to combine the required components monolithically on a substrate.

Thus, there is a need for optical monolithically integrated devices which at least in part overcome the problems in the technology today and further provide a solution to integrating multiple devices on a single chip for applications such as CWDM for high-speed data interconnects, 5G network communications, et al.

### SUMMARY OF INVENTION

The present application seeks to eliminate or mitigate one or more of the above-mentioned disadvantages of known devices and systems comprising hybrid devices on a single chip for applications such as CWDM for high-speed data interconnect, 5G network communications and the like.

According to a first aspect of the present application there is provided an optical receiver for receiving an optical input and providing an electrical output, the optical receiver comprising a demultiplexer, a waveguide photodiode (WG-PD), and electronic circuitry comprising a transimpedance amplifier (TIA) monolithically integrated on a semi-insulating (SI) substrate, the receiver comprising an epitaxial layer stack formed on the SI substrate; the electronic circuitry comprising the TIA formed by a first plurality of semiconductor layers of the epitaxial layer stack formed on the SI substrate; the WG-PD comprises a p-i-n (PIN) diode formed by a second plurality of semiconductor layers of the epitaxial layer stack horizontally distanced from the first plurality of semiconductor layers, the second plurality of semiconductor layers comprising an n-layer, an i-layer and a p-layer, wherein the WG-PD is configured to output a photocurrent to the TIA, the TIA configured to provide said electrical output; the demultiplexer horizontally distanced from the first plurality of semiconductor layers and formed from the second plurality of semiconductor layers, the demultiplexer having an optical input port and a plurality of optical output ports; and wherein the demultiplexer is configured to receive the optical input, and provide an optical output to each of the plurality of optical output ports, and an input of the WG-PD is optically coupled with one of the plurality of optical output ports of the demultiplexer.

In an aspect, the receiver comprises a plurality of WG-PDs and a plurality of TIAs, each of the plurality of WG-PDs being optically coupled to a respective one of the plurality of optical output ports of the demultiplexer.

In an aspect, the receiver comprises a plurality of TIAs and a plurality of WG-PDs in a one-to-one relationship.

In an aspect, the demultiplexer has N-channels and there are N WG-PDs and N TIAs.

In an aspect, the second plurality of semiconductor layers are photonics layers.

In an aspect, the first plurality of semiconductor layers are electronics layers.

In an aspect, the second plurality of semiconductor layers comprise a first set semiconductor layers and a second set of semiconductor layers and wherein the WG-PD is formed by the first set semiconductor layers and the demultiplexer is formed by the second set semiconductor layers.

In an aspect, the demultiplexer communicates with the PD via an optical connection between the WG-PD and the demultiplexer.

In an aspect, the optical connection comprises a laterally tapered vertical optical coupler.

In an aspect, the optical connection comprises a laterally coupled optical waveguide.

In an aspect, the demultiplexer is designed via an AI-based inverse design process.

In an aspect, the demultiplexer is designed via an AI-based inverse design process trained on one or more of an AI model, an optimizer and a simulator; and configured to have inputs that determine one or more optical characteristics of the demultiplexer.

In an aspect, the AI-based inverse design process produces an output that meet the inputs wherein the output comprises one or more of an empirical structural detail including geometry parameters of the demultiplexer, a pixelated structure, a voxelated structure or a QR type code-like structure which sets out a simple dot-based structure of the demultiplexer, or a full topological structure of the demultiplexer.

In an aspect, the electronic circuity comprises the TIA comprises InP heterojunction bipolar transistors (HBTs).

In an aspect, the SI substrate comprises a SI Indium Phosphide (InP) substrate.

In an aspect, for example the device structure is fabricated with an InP-based materials system comprising binary, ternary, quaternary and other compositions of In, Ga, As, Al, P and Sb.

In an aspect, electrical contacts of the WG-PD are directly interconnected to an input of the TIA by conductive traces.

In an aspect, the first plurality of semiconductor layers of the epitaxial layer stack are separated from the second plurality of semiconductor layers of the epitaxial layer stack by a spacer layer.

In an aspect, the spacer layer comprises a semi-insulating layer.

In an aspect, the demultiplexer demultiplexes the optical signal input into a plurality of wavelengths, each output port of the demultiplexer outputting a selected one of the plurality of wavelengths.

In an aspect, the electronic circuitry comprises electronic devices for controlling or driving the TIA and/or the WG-PD.

In an aspect, the TIA is formed on a first area of the substrate, and the WG-PD is provided on an adjacent area, and comprising an isolation region electrically isolating the first plurality of semiconductor layers of the first area from the second plurality of semiconductor layers of the adjacent area.

In an aspect, the i-layer is selected from materials of the group comprising InGaAs and other absorption materials within the InGaAlAsP quintenary system.

In an aspect, the i-layer comprises InGaAs.

In an aspect, the i-layer comprises a quaternary absorption material within the InGaAlAsP quintenary system, lattice matched to InP.

In an aspect, the i-layer comprises a multi-quantum well Quantum Confined Stark Effect (MQW QCSE) structure.

According to a second aspect of the present application there is provided an optical transmitter for transmitting an optical output from an electrical input, the optical transmitter comprising electronic circuitry comprising an electro-absorption modulator (EAM) driver, an EAM and a multiplexer monolithically integrated on a semi-insulating (SI) substrate, the transmitter comprising an epitaxial layer stack formed on the SI substrate; the electronic circuitry comprising the EAM driver formed by a first plurality of semiconductor layers of the epitaxial layer stack formed on the SI substrate; the EAM is formed by a second plurality of semiconductor layers of the epitaxial layer stack horizontally distanced from the first plurality of semiconductor layers, wherein the EAM driver is configured to output a photocurrent to the EAM, the EAM driver configured to receive said electrical input; the multiplexer horizontally distanced from the first plurality of semiconductor layers and formed from the second plurality of semiconductor layers, the multiplexer having a plurality of optical input ports and an optical output port; and wherein the multiplexer is configured to receive a plurality of optical inputs on each of the plurality of optical input ports , and provide an optical output to the optical output port , and an output of the EAM is optically coupled with one of the plurality of optical input ports of the multiplexer.

In an aspect, the transmitter comprises a plurality of EAMs and a plurality of EAM drivers, each of the plurality of EAMs being optically coupled to a respective one of the plurality of optical output ports of the multiplexer.

In an aspect, the transmitter comprises a plurality of EAM drivers and a plurality of EAMs in a one-to-one relationship.

In an aspect, the multiplexer has N-channels and there are N EAMs and N EAM drivers.

In an aspect, the second plurality of semiconductor layers are photonics layers.

In an aspect, the first plurality of semiconductor layers are electronics layers.

In an aspect, the second plurality of semiconductor layers comprise a first set semiconductor layers and a second set of semiconductor layers and wherein the EAM is formed by the first set semiconductor layers and the multiplexer is formed by the second set semiconductor layers.

In an aspect, the multiplexer communicates with the EAM via an optical connection between the EAM and the multiplexer.

In an aspect, the optical connection comprises a laterally tapered vertical optical coupler.

In an aspect, the optical connection comprises a laterally coupled optical waveguide.

In an aspect, the multiplexer is designed via an AI-based inverse design process. In an aspect, the multiplexer is designed via an AI-based inverse design process based on a trained on one or more of an AI model , an optimizer and a simulator; and configured to have inputs that determine one or more optical characteristics of the demultiplexer.

In an aspect, the AI-based inverse design process produces an output that meet the inputs wherein the output comprises one or more of an empirical structural detail including geometry parameters of the multiplexer, a pixelated structure, a voxelated structure or a QR type code-like structure which sets out a simple dot-based structure of the multiplexer, or a full topological structure of the multiplexer.

In an aspect, the SI substrate comprises a SI Indium Phosphide (In P) based material substrate.

In an aspect, the SI substrate comprises a SI Indium Phosphide (In P) substrate

In an aspect, electrical contacts of the EAM are directly interconnected to an input of the EAM driver by conductive traces.

In an aspect, the first plurality of semiconductor layers of the epitaxial layer stack are separated from the second plurality of semiconductor layers of the epitaxial layer stack by a spacer layer.

In an aspect, the spacer layer comprises a semi-insulating layer.

In an aspect, the multiplexer multiplexes the optical signal inputs from a wavelength from each input port, the multiplexer outputting the plurality of wavelengths.

In an aspect, the electronic circuitry comprises electronic devices for controlling or driving the EAM driver and/or the EAM.

In an aspect, the EAM driver is formed on a first area of the substrate, and the EAMis provided on an adjacent area, and comprising an isolation region electrically isolating the first plurality of semiconductor layers of the first area from the second plurality of semiconductor layers of the adjacent area.

According to a third aspect of the present application, there is provided an optical system including an optical transmitter according to another aspect of the application.

According to a fourth aspect of the present application there is provided an optical system including an optical receiver according to another aspect of the application.

According to a fifth aspect of the present application, there is provided an optical system including an optical receiver according to another aspect of the application and an optical transmitter according to another aspect of the application.

According to a further aspect of the application there is provided a photonic device for receiving an input and providing an output, the photonic device comprising: an electronic circuitry comprising at least one electronic device; an optical waveguide device; and an optical multiplexing device configured to provide one of multiplexing and demultiplexing of optical channels; wherein the electronic device, the optical waveguide device and the optical multiplexing device are monolithically integrated on a semi-insulating (SI) substrate and comprise an epitaxial stack including a first plurality of semiconductor layers and a second plurality of semiconductor layers; and the at least one electronic device is formed by the first plurality of semiconductor layers of the epitaxial layer stack; the waveguide device comprises a p-i-n (PIN) device formed by the second plurality of semiconductor layers of the epitaxial layer stack, the second plurality of semiconductor layers comprising an n-layer, an i-layer and a p-layer, and the optical multiplexing device formed from the second plurality of semiconductor layers and positioned apart from the optical waveguide device and the at least one electronic device, the optical multiplexing device having one or more optical input ports and a one or more optical output ports; wherein the optical multiplexing device, the waveguide device and the at least one electronic device are configured to receive the input and provide the output.

Some further aspects provide one of:

a. photonic device comprising monolithic integration of an array of WG-PDs and a DEMUX, without monolithically integrated electronics,

b. a photonic device comprising monolithic integration of an array of EAMs and a MUX without monolithically integrated electronics and

c. a combination of a. and b.

It will be appreciated that any combination of the aspects above can be combined with any other aspects to form combinations not specifically stated in the claims or description.

While example aspects of monolithically receiver including integrated PIN-TIA and demultiplexer (PIN-TIA-DEMUX) are described with reference to implementation using an InGaAs PIN and TIA circuitry fabricated with InP HBTs, the design methodology may be extended to other forms of PD implemented using InP-based materials process technology, for example, where the PD is an APD or a waveguide PIN (lateral facet window) instead of a vertical PIN (top facet window). Design parameters of the latter may be optimized to provide an integrated PD-TIA meeting performance specifications for an optical receiver of an ONU or OLT for 10G PON, or for other applications requiring high data rate optical detectors for applications such as CWDM for high-speed data interconnect, 5G network communications. Where the device is a transmitter, similar variations may be used and further different electro-absorption modulators (EAM), EAM drivers, modulators, multiplexers and equivalent alternatives may be used.

In addition, different forms of demultiplexer and multiplexer technology and methodologies that are compatible with monolithic integration with photonics and electronics components may be employed.

Other applications may include 5G and database technology using multiple wavelengths, although the wavelengths of operation may be somewhat different from PON. The proposed technologies and methodologies to other lower speed operations such as currently deployed 506GB, 112Gb/s PAM4 data communications

Elements of monolithically integrated PIN-TIA, PIN PD, EAM, EAM drivers, modulators, demultiplexer and multiplexer of example aspects may be combined with elements of other aspects, where appropriate. For example, monolithically integrated PIN-TIA, PD-TIA; EAM, EAM drivers, modulators, demultiplexer and multiplexer of other embodiments may comprise any feasible combination of individual features disclosed herein.

Another aspect of the application provides a method of fabrication of device structures, comprising monolithically integrated devices for optical receivers as disclosed herein.

The foregoing and other objects, features, aspects and advantages of the present application will become more apparent from the following detailed description, taken in conjunction with the accompanying drawings, of some embodiments of the application, which description is by way of example only.

### BRIEF DESCRIPTION OF THE DRAWINGS

FIG. 1 (Prior Art) shows a schematic functional block diagram of an optical receiver comprising a hybrid photodiode detector PD and a TIA.

FIG. 2a shows a schematic functional block diagram of a WG-pin PD according to an aspect of the present application.

FIG. 2b shows a cross-sectional view of the PIN PD of FIG. 2a

FIG. 3a shows a schematic functional block diagram of a WG-pin PD and a TIA according to an aspect of the present application.

FIG. 3b shows a cross-sectional of the WG-pin PD and a TIA of FIG. 3a

FIG. 4 shows an example epitaxial layer structure for monolithic integration of multiple WG -pin PD with electronic circuitry, e.g. comprising a TIA according to an aspect of the present application.

FIG. 5 shows a simplified perspective view of part of a monolithically integrated circuit comprising a plurality of WG -pin PD integrated with electronic circuitry comprising a TIA according to an aspect of the present application.

FIG. 6a shows a monolithically integrated electro-absorption modulators (EAM) and EAM Driver chip according to an aspect of the present application.

FIG. 6b is a simplified cross-sectional view of an epitaxial structure for the FIG. 6a structure.

FIG. 7 shows a schematic functional block diagram of an optical distribution networks according to an aspect of the present application.

FIG. 8 shows a simplified schematic diagram of a receiver and transmitter according to an aspect of the present application.

FIG. 9 shows a schematic view of a monolithic multidevice receiver according to an aspect of the present application.

FIG. 10 shows a schematic view of a monolithic multidevice transmitter according to an aspect of the present application.

FIG. 11a is a simplified cross-sectional view of an epitaxial structure for a monolithically integrated optical receiver including a longitudinal cross-section through one WG-pin PD of a vertical optical coupling of a DEMUX and WG-pin PD according to an aspect of the present application.

FIG. 11b is a simplified cross-sectional view of an epitaxial structure for a monolithically integrated optical receiver including a longitudinal cross-section through one WG-pin PD of a vertical optical coupling of a DEMUX and WG-pin PD according to an aspect of the present application.

FIG. 11c is a simplified cross-sectional view of an epitaxial structure for a monolithically integrated optical receiver including a longitudinal cross-section through one WG-pin PD of a lateral optical coupling of DEMUX and WG-pin PD according to an aspect of the present application.

FIG. 11d is a simplified cross-sectional view of an epitaxial structure for a monolithically integrated optical receiver including a longitudinal cross-section through one WG-pin PD of a lateral optical coupling of DEMUX and WG-pin PD according to an aspect of the present application.

FIG. 12a is a simplified cross-sectional view of an epitaxial structure for a monolithically integrated optical transmitter including a longitudinal cross-section through one EAM of a vertical optical coupling of MUX and EAM according to an aspect of the present application.

FIG. 12b a simplified cross-sectional view of an epitaxial structure for a monolithically integrated optical receiver including a longitudinal cross-section through one EAM of a lateral optical coupling of MUX and EAM according to an aspect of the present application.

FIG. 12c is a simplified cross-sectional view of an epitaxial structure for a monolithically integrated optical transmitter including a longitudinal cross-section through one EAM of a vertical optical coupling of MUX and EAM according to an aspect of the present application.

FIG. 12d a simplified cross-sectional view of an epitaxial structure for a monolithically integrated optical receiver including a longitudinal cross-section through one EAM of a lateral optical coupling of MUX and EAM according to an aspect of the present application.

### DETAILED DESCRIPTION

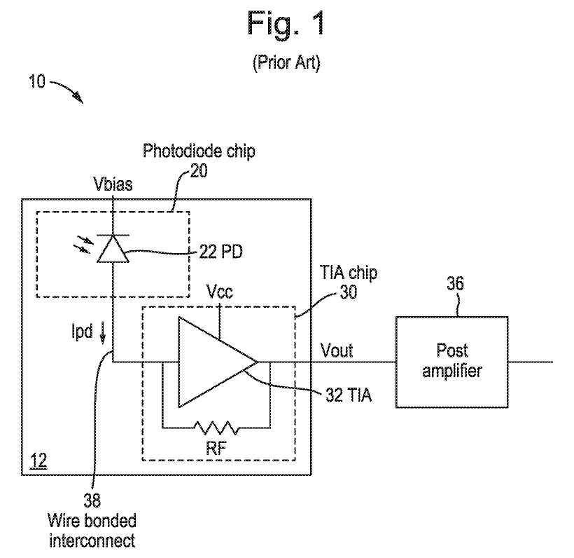

A schematic functional block diagram of an optical receiver comprising a hybrid assembly 10 of a package substrate 12, a photodiode chip 20 comprising a photodiode (PD) 22 and a TIA chip 30 comprising a TIA 32 with feedback resistor R_{F}, and a discrete post amplifier 36, is shown in FIG. 1. The photodiode chip 20 is interconnected to the TIA chip 30 with wire bonded interconnect 38, to feed photocurrent I_{PD} to the TIA 322 to generate output voltage Vₒᵤₜ. The photodiode PD may be an APD, or a pin PD (PIN), or another type of photodiode, depending on the required performance specifications. Typically, for GPON and 10GPON, to provide the required sensitivity, e.g. better than -28.5dBm, the photodiode is an APD. As mentioned in the background section, it is possible to replace a hybrid APD-TIA with a lower cost monolithically integrated PIN-TIA with comparable performance and sensitivity. This type of device is used in the present application as the preferred monolithically integrated PIN-TIA combination.

Conventional wire bonded interconnections of a hybrid PIN-TIA optical receiver add significant parasitics, which limit performance of a PIN-TIA. In particular, the bond pads add capacitance and bond-wires add inductance. It will also be appreciated that the consistency of wire-bonded interconnections of hybrid components tend to be dependent on the type of packaging used, and in practice, some variability or inconsistencies in wire-bonded interconnections for individual optical receiver units may be expected. These variabilities or inconsistencies in wire-bonding lead to corresponding variabilities or inconsistencies in parasitic capacitances and inductances of hybrid PIN-TIA.

Monolithically integrated PIN-TIA used in aspects of the present application offer an alternative to conventional hybrid APD-TIA for high-speed data communications, with at least comparable performance, and potentially offer performance improvements and/or cost reductions relative to other hybrid PD-TIA combinations.

In a conventional hybrid arrangement of a PIN and a TIA, e.g. as shown in FIG. 1, two bond pads, i.e. an n-pad and a p-pad, e.g. 75μm 50Ω pads, may be required to connect the PD to the TIA with wire bonds. Both pads of the PD add capacitance, which can be a significant fraction of the total capacitance of the device. A typical device capacitance in a range of 65nF to 80nF.

Taking some example InGaAs PIN devices of different areas, which have publicly available datasheets, and working backwards from information on the datasheets, it is estimated that the parasitic capacitance of the bond pads contributes roughly half of the total device capacitance. This estimate is derived by extrapolation to zero device area based on typical capacitance and maximum capacitance data for devices of different device areas.

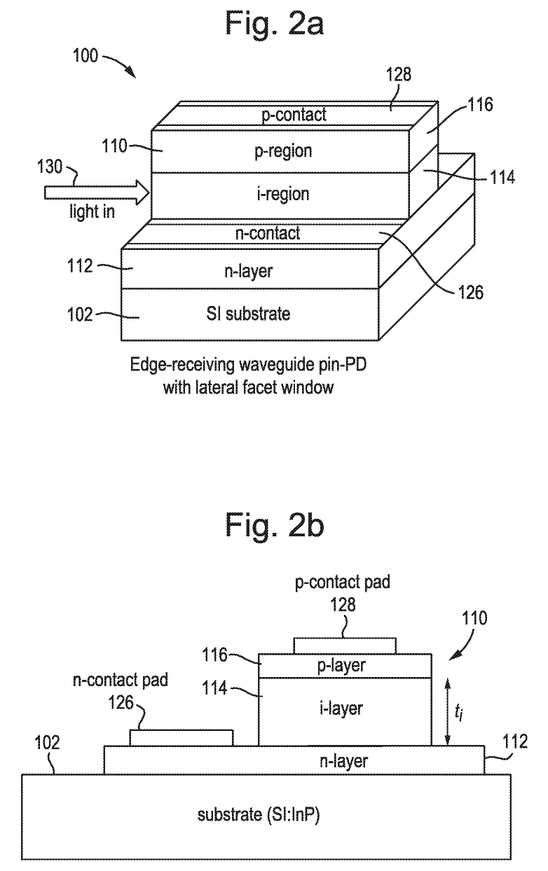

FIG. 2a and 2b show respectively a schematic cross-sectional view and a true cross-sectional view of an InGaAs PIN device structure 100 showing the p-i-n layer structure 110 comprising an n-layer 112, an i-layer 114 and a p-layer 116 formed on a semi-insulating (SI) substrate 102, for example indium phosphide (InP) 102. The i-layer has a thickness tᵢ. The PIN device is essentially a pn-junction separated with an intrinsic (i)-layer of absorption material such as InGaAs. Bond pads comprise a p-contact pad 128 and an n-contact pad 126. The n-layer 112 is interconnected to the n-contact pad 126. The capacitance Cpin of the p-i-n junction itself is necessary for device operation. A finite junction capacitance is necessary to balance off RC with carrier transit time. However, the bond pad capacitance adds no useful functionality, and ideally the bond pad capacitance would be zero. Light enters laterally via fiber 130.

Monolithic integration of the PIN and TIA eliminates the bond pad capacitance, and bond wire inductance, by design. For example, it is possible to integrate a InGaAs pin with a TIA fabricated using InP heterojunction bipolar transistors (HBTs). This means there is a direct on-chip interconnection, i.e. a lithographically defined conductive trace, from the output of the pin to the input of the TIA. Preferably the conductive trace between the PIN and TIA provides a short, low resistance, low inductance interconnection, eliminating the need for impedance matching. Thus, one of the 50Ω bond pads of the pin is eliminated because there is a direct interconnection, not a wire bond connection between the PIN and TIA. Since the conductive trace providing the direct interconnection between the PIN and TIA is lithographically defined, i.e. Using one or more interconnect metallization layers, the PIN-TIA interconnection is more reproducibly and consistently defined, for each PIN-TIA on a wafer, and from wafer-to-wafer, and from batch-to-batch.

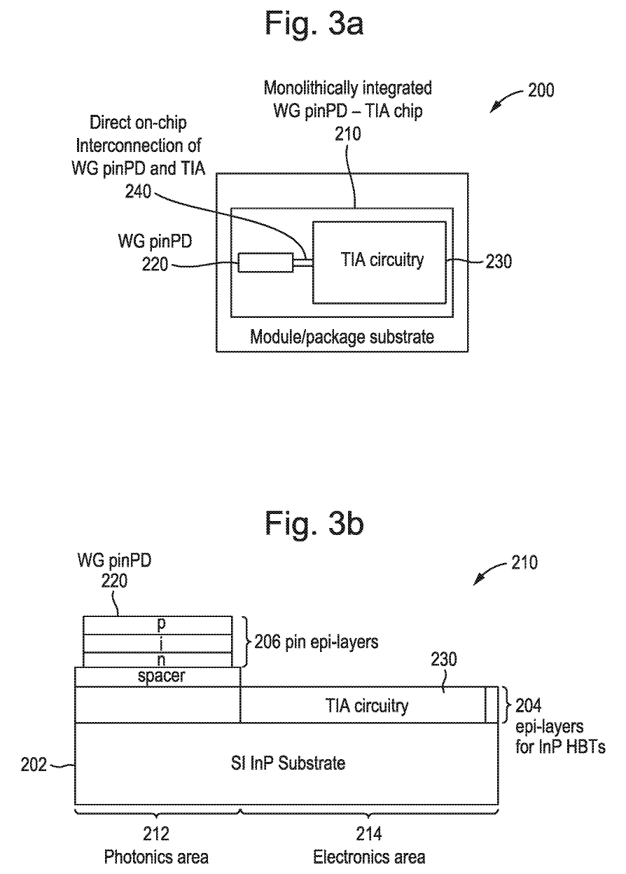

A schematic device topology (top plan view) for a monolithically integrated PIN-TIA of an example embodiment 200 is shown in FIG. 3A. The monolithically integrated PIN-TIA chip 210 comprises a PIN device structure 220 and TIA circuitry 230. There is a direct on-chip interconnection 240 between the p-contact of the PIN 220 and the TIA circuitry. A schematic cross-sectional view of the monolithically integrated PIN-TIA chip 210 comprising a semi-insulating substrate 202 is shown in FIG. 3B, to illustrate monolithic integration of HBT epitaxial layers 204 for the TIA and horizontally distanced or overlying epitaxial layers 206 to form the PIN is shown in FIG. 3B. Although the opposite terminal of the PIN is coupled to a bond pad (i.e. a ground pad), the capacitance of this pad is actually decoupled from device operation. Since the output of the PIN is directly coupled to a first stage amplifier of the TIA by a conductive trace 240 providing a direct on-chip interconnection, in effect, the pad capacitance of the PIN does not figure into device operation. This has multiple useful consequences.

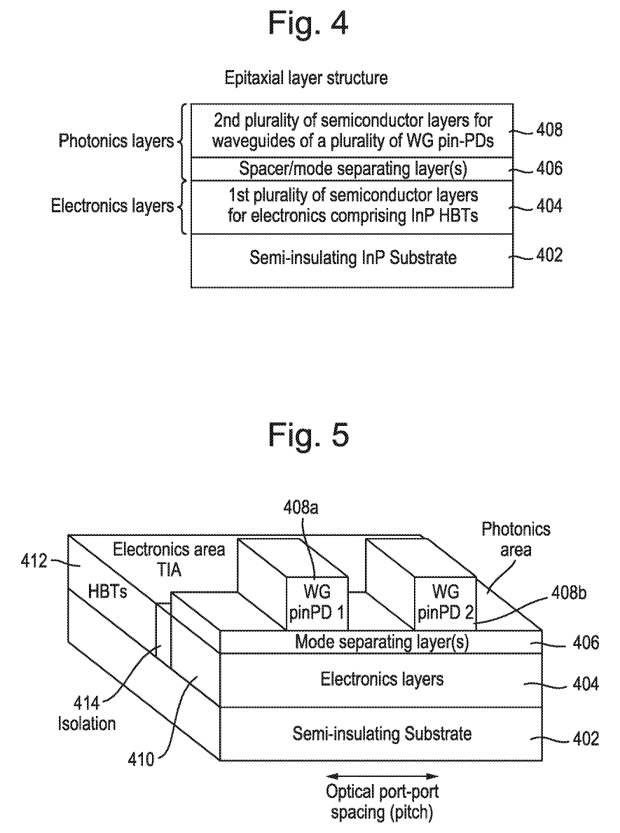

FIG. 4 is a simplified schematic cross-sectional view of an epitaxial structure for a monolithically integrated waveguide PD and TIA 400 according to an aspect of the present application. The monolithic device comprises a semi insulating (SI) III-V material substrates 402. In an example this is SI InP. Electronic layers 404 are added to provide a first plurality of semiconductor layers for electronics comprising InP HBTs in an example. A space or mode separating layers 406 separates the first plurality of layers from a second plurality of semiconductor layers for waveguides of a one or more WG-pin PDs 408.

The WG-pin PDs comprise the materials as described elsewhere in this description and generally comprise one or more III-V materials, e.g. an InP-based material system, comprising binary, ternary, quaternary and other compositions of In, Ga, As, P, Al and Sb. The first plurality of layers comprise electronics and associated functionality, e.g. for fabrication of InP heterojunction bipolar transistors (HBTs). The second plurality of layers comprises photonic layers and associated functionality. For fabrication of WG-pin PDs, the photonics layers comprise an i-region comprising absorption material, sandwiched between an n-InP layer and p-InP layer. In some embodiments, the absorption material of the i-region comprises InGaAs, or a quaternary absorption material selected from within the InGaAlAsP quintenary system, which is lattice matched to InP. In some embodiments the absorption material of the i-region comprises a Quantum Confined Stark Effect (QCSE) multi-quantum well (MQW) structure.

Using materials of this nature enables very high-speed modulation to be achieved. A semi-insulating substrate is beneficial in reducing device capacitance. In addition, Quantum Efficiency and other parameters, such as sensitivity, responsivity and dynamic extinction ratio are also improved. For fabrication on an SI substrate there is reduced overall capacitance which improves electrical performance. The receiver has improved sensitivity and responsivity of WG-PIN PD. The transmitter has a dynamic extinction ratio of the EAM which provides improvements over other designs.

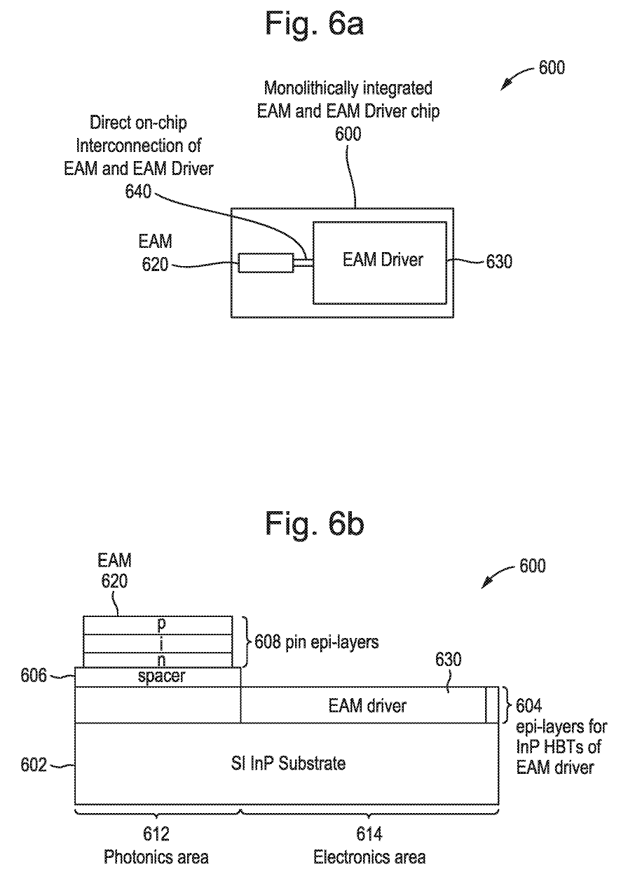

FIG. 5 shows a schematic view of part of an optical transmitter which is a device structure comprising first and second WG-pin PDs 408a and 408b and electronic circuitry comprising a TIA, fabricated with HBTs, based on the epitaxial layer structure shown in FIG. 4 structure. Electrical connections between the WG-pin PDs and the TIA are omitted from this diagram. It will be appreciated that in accordance with an aspect of the application, there are interconnects between any optical device and electronic device according to techniques which will be appreciated by the skilled person. The area of the chip is defined by the semi-insulating substrate 402. Layers 404 includes multiple electronics devices 410 and 412 including but not limited to TIAs and any other drivers or control electronics for any other associated component or device located on the chip. An isolation layer 414 separates the active electronics layers, comprising the electronic circuitry from the remaining electronics layers underlying the photonics layers. Atop the electronics layer is a mode separating layer 406 and two WG-pin PDs 408a and 408b at the mode separating layer 406 and the underlying electronics layers 404. That is, the mode separating layer 406 vertically separates the photonics layers of the WG-pin PD from the remaining underlying electronics layers, and the isolation region laterally separates the photonics structures from the active electronic devices. One or more metallization layers provide electrical connection between each WG-pin PD and a respective TIA (electrical connections not shown in FIG. 5).

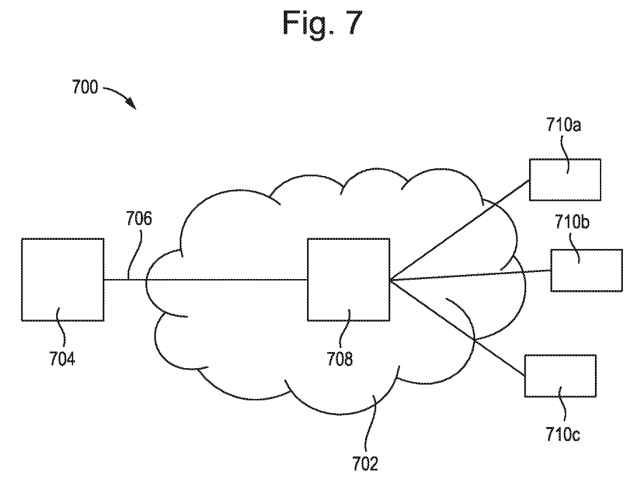

United States patents 10,673,532 and 10,530,484 disclose device structures for monolithic integration of an electro-absorption modulators (EAM) and EAM driver circuitry for an optical transmitter. For example, FIGS. 6a and 6b herein are adapted from FIGS. 3A, 3B and 3C of these patents. FIG. 6a shows a schematic plan view of a monolithic electro-photonic integrated circuit 600 comprising an EAM 620 with integrated EAM driver circuitry 630 which as adapted forms part of a transmitter according to aspects of the application. FIG. 6b shows a simplified cross-sectional view of an epitaxial layer structure for fabrication of a monolithic electro-photonic integrated circuit 600 comprising an EAM 620 with integrated EAM driver circuitry 630 of FIG. 6a. FIG. 6b also shows the underlying semi-isolating substrate 602 and a first plurality of semiconductor layers 604 for electronics, comprising InP EAM driver layers, in an example of HBTs. A spacer 606 separates the first plurality of semiconductor layers from a second plurality of semiconductor layers 608 forming the EAM 620. It will be appreciated that other examples may be used, and the design may vary depending on requirements and processing constraints such as chip dimension requirements and the like.

The abovementioned monolithically integrated PIN-TIA is combined with a demultiplexer in aspects of the present application as described in greater detail below. The present application makes use of AI-based inverse design processes to produce a design for a demultiplexer to integrate with a monolithic arrangement having a PIN-TIA as described herein. The ability to use AI-based inverse design techniques means that a very compact device can be designed and in combination with the small scale of the WG-pin PD offers a solution to many problems associated with providing a small, efficient and compact receiver. In addition, designing in III–V semiconductor materials provide other advantages over typical silicon-based semiconductors. The combination of using III–V semiconductor materials, such as an Indium phosphide (InP)-based materials system, and the use of AI-based inverse design processes offers a distinct advantage in the quest for integrating devices for use in very high-speed environments requiring optical receivers and transmitters and similar devices and purposes. This will become further evident below.

The ability to design, using AI-based inverse design processes in InP semiconductor technology, also allows for a compact design of a multiplexer for use in a transmitter having similar qualities and advantages as the demultiplexer, for multiwavelength applications such as CWDM. This will also become further evident below.

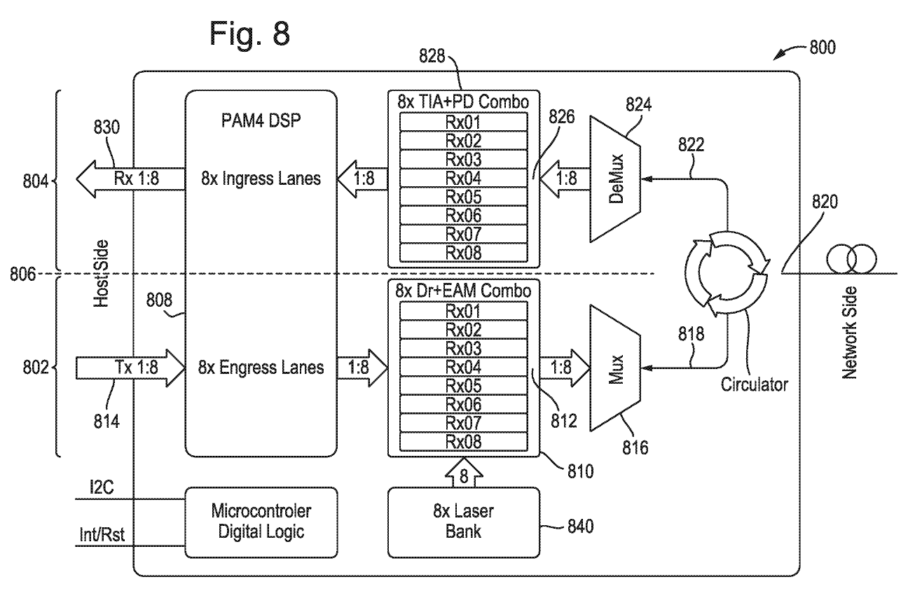

FIG. 7 shows a distributed network system 700, according to an aspect of the present application and which is configured to transmit and receive signals made up of multiple wavelengths. For example, applications such as CWDM for high-speed data interconnect, 5G network communications. The system 700 is configured to operate with a network 702 supporting a relevant application. A transmitter 704 at a service provider communicates via an optical signal 706 with receivers 710a, 710b, 710c at respective multiple locations. The network may include a device 708 for directing the transmitted signal to individual receivers. The nature in which this occurs is a beam splitter that can split the input into a plurality of outputs each destined for a particular location. There may be multiple beam splitters in the network depending on the nature of the original signal and the destinations. For example, a splitter per customer and a splitter per user.

It will be appreciated that the transmitter 704 may include equivalent beam combiners or reverse beam splitters to combine multiple beams into a composite signal optical for transmission across the network. The transmitter may also include laser devices or modulators to generate the optical signal to be transmitted to the receivers, this will be described in greater detail below.

The system may include other devices and components as needed as will now be described in further detail, the system may include multiplexing and demultiplexing capabilities. The transmitter may include a multiplexer and the or each receiver may include a demultiplexer. In an aspect of the present application the multiplexer and demultiplexer are designed using Artificial-Intelligence (AI)-based inverse design techniques. After design, the respective multiplexer and demultiplexer are included in a respective single monolithic integrated transmitter and a respective single monolithic integrated receiver. In addition, an aspect of the present application provides a single monolithic integrated receiver and transmitter, such as that described below.

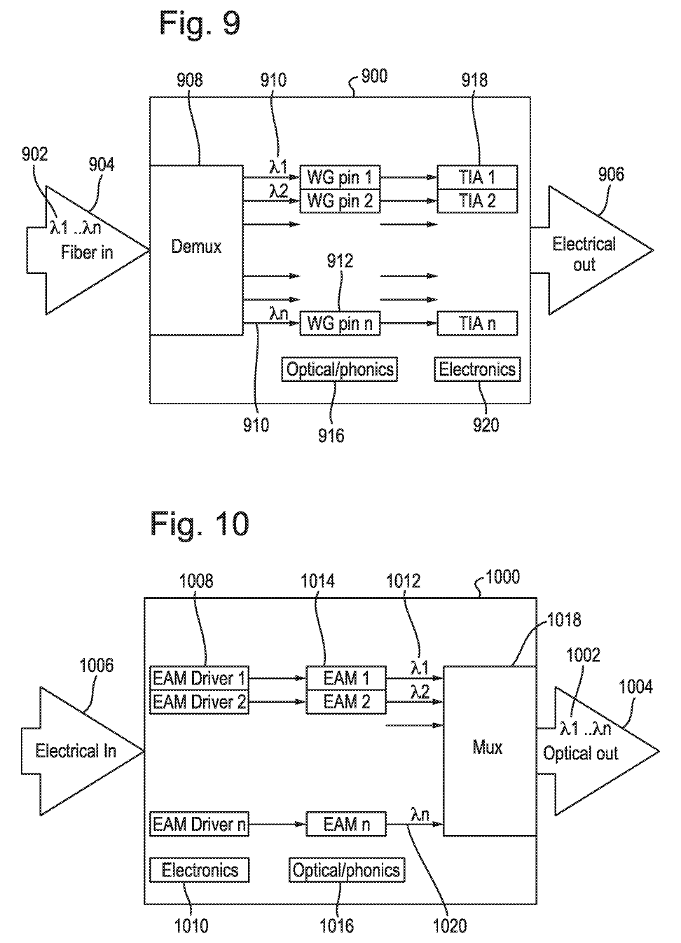

FIG. 8 is a simplified diagram of an end-to-end system configuration 800 of a transmitter side 802 and receiver side 804 according to an aspect of the present application. Dotted line 806 shows the separation between the components of the transmitter 802 and the receiver 804 which may be formed on a single chip in some examples. The transmitter includes a digital signal processor 808 and an 8-channel EAM or similar driver 810 to produce optical signals TX01-TX08812 from input electrical signals 814. TX01-TX08 each represents a different wavelength of radiation produced by a laser source (840). The wavelengths extend between 1310 and 1577nm. The separation between wavelengths across the wavelength range can vary and for example by 5 or 10 nm intervals around a central wavelength. The digital processor may include an integrated driver suitable for direct connection to an optical modulator, on-board management and a DSP-based equalizer such that the chip can support optical links up to and beyond 10 km over a single mode fiber. The wavelengths TX01-TX08 are combined by an 8-channel multiplexer 816 to form output 818 which is a multiplexed combination of the different wavelengths of TX01 to TX08. The output 818 is passed via a fiber 820 and is received as input 822 at the receiver side 804 by a demultiplexer 824. The demultiplexer separates the different wavelength components of the input 822 into respective received individual wavelengths RX01 to RX08826. The wavelengths of the received signals are substantially the same as the transmitted signals. TX01 and RX01 are the same wavelength, TX02 and RX02 are the same and so on. The received wavelengths RX01-RX08 are passed to individual TIA circuits shown in this figure as an 8-channel TIA array 828 to be converted into electrical signals which are output 830 of processor 832.

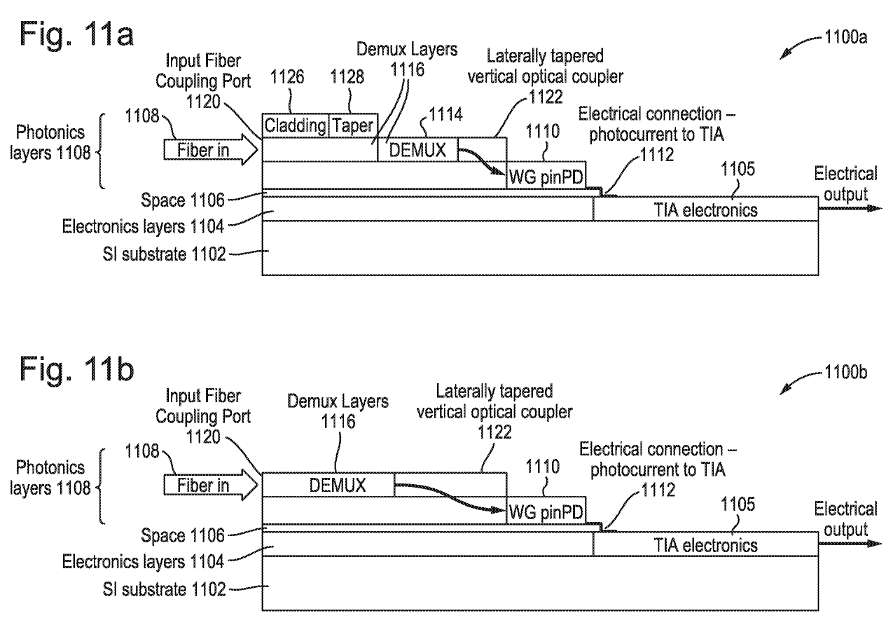

FIG. 9 shows a single chip monolithic receiver 900 configured to receive optical signal 902 via a fiber in 904 and to output an electrical output 906. The optical signal 902 comprises wavelengths λ₁ to λₙ and is first passed through a demultiplexer 908 to generate individual wavelength outputs λ₁, λ₂, λₙ910. Each wavelength passes from the demultiplexer 908 along waveguides 910 through an array of waveguide photodiodes such as PIN photodiodes as described above (WG-PIN₁ to WG-PINₙ) 912. In an aspect of the application, there are the same number of WG-pin PD devices (n) as wavelengths (n) generated through the demultiplexer. In an aspect of the application the demultiplexer may be an 8-channel demultiplexer or a 16 channel demultiplexer. If the demultiplexer is a 16-channel demultiplexer, there will be 16 waveguides and 16 WG-pin PDs. The Demultiplexer is a passive optical device.

The WG-pin PDs include an electrical contact or other optical or photonic control electronics 916. Photocurrent from each wavelength λ₁, λ₂, λₙ is passed to an array of transimpedance amplifiers (TIA) 918 and output as multiple electrical steams 906. The TIAs include control and driver circuits and any other necessary electronic components, 920. In an aspect of the application, each WG-pin PD is paired with a specific TIA and the array of WG-pin PDs is the same magnitude as the array of TIAs, in an aspect there are eight of each, but other numbers can be envisaged depending on the size of the demultiplexer and other factors. There may be an N-to-N relationship between the number of channels, the number of TIAs and/or the number of WG-pin PDs. This one-to-one relationship is important at high frequencies as there is a reduced delay in generating the overall output. In situations where high frequency throughput is less important, a one-on-one relationship between a WG-pin PD and a TIA may not be needed and a time division multiplexing of inputs to TIAs for a pair or other multiple of WG-pin PDs may be envisaged.

The wavelengths mentioned in FIG. 9 are of a similar nature to those mentioned above despite the different nomenclatures, e.g. a plurality of wavelengths selected from e.g. O-band, L-band, C-band.

It will be appreciated that the array of WG-pin PDs may share optical or photonic control electronics 916 and the array of TIAs may share electronic components 920. This means that the control circuitry for each array can be reduced in size relative to the case where each WG-pin PD includes control circuitry, and each TIA includes control electronics. This can make a distinct difference to the overall size of the monolithic receiver chip 900 on which the receiver is built. Similarly, the same scaling can occur in a transmitter-based circuit as will now be described. The circuits controlling the different devices may also be shared if there are common functionalities being carried out by each component part of the receiver or transmitter. An example might be processing which is common with all components.

The demultiplexer may include 5nm optical channel separation in an example. The device 900 has a structure in which the demultiplexer and WG-pin PDs are parallel to the underlying supporting semi-insulating substrate. “Fiber in” to demultiplexer to WG-pin PD is in the same direction or plane (X, Y) of propagation of the optical beam and provides a unique optical demultiplexer into WG-pin PD monolithic design. As a result, the overall device size in a direction Z (up and down into the figure) is only limited by the size of the TIA dimensions. The main factor relating to the size of the TIA is based on the necessary control and driver circuitry and as a result any possibility to avoid duplication in respect of this circuitry has advantages in terms of the overall dimensions of the receiver or transmitter. As stated elsewhere, the dimension can be reduced further by sharing the electronic control and driver components between TIAs and between different components.

A further consequence of “Fiber in” to demultiplexer to WG-pin PD is in the same direction or plane is that the dimensions of the demultiplexer can be minimized as compared to a surface illuminated demultiplexer as has been used in alternative concepts. Surface illumination requires a relatively large device to ensure adequate capture of the light. By compression “fiber in” via a cable is already compacted into a relatively small diameter and thus requires a smaller input window for the demultiplexer than surface illumination requires.

In an alternative design a three-dimensional demultiplexer may be used, in which fiber in is vertically split into vertically stacked WG-pin PDs. The wavelengths are separated over more than one plane which may reduce the amount of space taken up by the WG-pin PDs. Similarly, the TIAs may be stacked providing more space saving possibilities.

The demultiplexer of an aspect of the application is designed in accordance with an AI-based inverse design process comprised of multi-objective optimizers, physics simulators, and AI models that were trained for generating passive photonic components like demultiplexers or multiplexers. In order to accomplish this, there are a number of steps to consider and optimize in order to achieve a feasible design for the demultiplexer. For all situations the input to the design process is a definition of the required optical response of the device in question, in this case a demultiplexer and a multiplexer for receiver and transmitter respectively.

The optical response or the performance criteria provide the input for the trained AI models, optimizers and simulators. For example, one or more optical characteristics such as network capacity, spectral efficiency, optical power budget, and redundancy. Network capacity and spectral efficiencies are used to ensure future proofing and compatibility with other factors. Channel spacing, including separation between the wavelengths used in the demultiplexer and spectral efficiency may require careful consideration along with channel allocation, modulation formats, and dispersion compensation techniques. The optical power budget to ensure reliable signal transmission and factors including fiber attenuation, connector losses, and dispersion may also be considered. In addition, the geometry and/or dimensions of the device and the required optical port-port spacing may further be considered. These are just some of the inputs that may be required for an AI model within the inverse design process to infer the nature of a possible design for the resultant demultiplexer or multiplexer having the required optical characteristics.

The input data is passed through the trained AI model, and outputs are generated based on the inputs. The training data for the process, obtained from physics simulators and the like, includes designs of demultiplexers or multiplexers and their optical characteristics and responses. In this way the model has learned the optical response of known devices and is able to output the required parameters of a device having the input parameters entered as the input.

There are different end points or outputs in the inverse design process. The output could include empirical structural details including the device geometry parameters which include a number of parameters x₁, x₂, … xₙ. Each parameter may define a position, material and size as examples. An alternative output after running the inputs through the AI-based inverse design process is a pixelated structure, a voxelated structure or a QR type code-like structure which sets out a simple dot-based structure that will provide an example of the restrictions to light passing through the intended structure. The pixelated output comprises a design of materials to form a simplified pixel and/or voxel based demultiplexer having material for two different types which are compatible with the processing technology. In this case, the materials are compatible with InP-based materials used for photonic and electronic components. From this output a candidate device can be output that can be tested by simulation or the like without committing to a full topological structure being built. If this output is failing in any way the design can be remodeled using new inputs that take into account, the deficiencies of the design and a new design can be generated. Changes in the optical response can be modeled, tested and then remodeled by simply changing the inputs and re-running the AI-based inverse design process until a structure having the necessary optical characteristics and is compatible with the In P-based fabrication process is reached. This means there is no detailed fabrication until a suitable pixelated structure or voxelated structure has been confirmed as a likely to candidate produce the required optical and fabrication-based characteristics.

A third output may be a full topological structure which once built can be tested to determine if this has satisfactory optical characteristics. Re-modelling may be required after testing and the topology may be output in any necessary format as required.

An aspect of the present application is that the use of optical responses in the InP based domains provides very small physical sized PDs. For example, each WG-PIN PD may have a waveguide ridge having a width in the order of 2-3µm and a length in the order of 30 µm and even as little as 15 µm. This gives a physical width to the PD, including contact areas for metallization of between for example about 15-20µm. The PDs may be laterally separated by for example a spacing ~10 µm. These dimensions would result in a port-to-port distance between PDs of the order of for example ~ 25-30µm. As a result, for an 8-channel demultiplexer to be comparable with these dimensions the demultiplexer only needs to be of the order of for example about 150-250µm. It will be appreciated that these dimensions are very approximate but it can be seen that a demultiplexer according to an aspect of the present application can easily be several times smaller than traditional waveguide demultiplexers. It will be appreciated that similar calculations apply to an 8-channel multiplexer. If the demultiplexer (or the multiplexer) has more channels the size will approximate multiplication of the number of PDs and the port-to-port size. In addition, as different sizes of devices (such as PDs) are possible for different types of materials different minimum sizes may be possible and the sizing to the AI inverse design features will be adjusted accordingly. This would include at least that which is necessary to provide an input to the TIA.

When using the AI-based inverse design process to generate the afore mentioned pixelated, voxelated or QR type code-like structure it will be appreciated that a workable device at the sizes suggested is achievable working with materials from the InP-based material system, comprising binary, ternary, quaternary and other compositions of In, Ga, As, P, Al and Sb. and compatible dielectric materials and metallization layers. Other types of output from the AI-based inverse design process are similarly achievable in InP-based materials.

A further output from the AI-based inverse design process is an indication of the materials that may be used to fabricate the multiplexer or the demultiplexer, e.g. suitable semiconductor and dielectric materials having required optical characteristics, such as refractive index. These include III–V semiconductor materials such as Indium phosphide (InP)-based materials system comprising binary, ternary, quaternary and other compositions of In, Ga, As, P, Al and Sb.

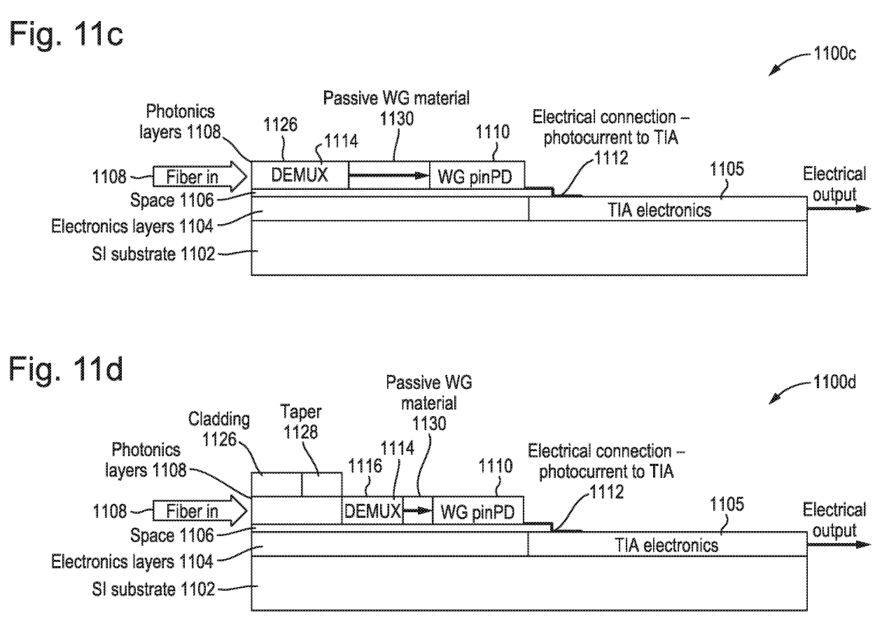

FIG. 10 shows a monolithically integrated transmitter 1000 which is configured to generate an optical signal 1002, comprising a plurality of wavelengths, via a fiber out 1004, intended to be transmitted, for example, to one or more receivers (not shown in FIG. 10; 900 in FIG. 9). The monolithically integrated transmitter 1000 is fabricated on a semi-insulating substrate such as InP, as an example. An electric input 1006 is input to an array of electro-absorption modulator (EAM) drivers 1008. Each EAM driver provides a driving signal to respective ones of a plurality of EAMs 1014. Each EAM may emit one of a plurality of optical or near optical wavelengths, e.g. wavelengths selected from the O-band, L-band and C-band, as mentioned as mentioned above. It is noted that the precise wavelengths may depend on the materials and may vary based on the materials used for fabrication of the EAMs. In FIG. 10 multiple EAM drivers 1008 are shown but this is not intended to be a limitation, and other numbers of EAM drivers may be used including just one. Each EAM driver may drive more than one EAM. The or each EAMis configured to output one or more of a plurality of wavelengths λ₁, λ₂, λₙ1012. The EAMs include optical and/or photonic electronics 1016 to provide control functionalities. There may be a one-to one relationship between each of the plurality of wavelengths, the EAM drivers and the EAMs. There may be a different number of EAM drivers to EAMs in cases where lower speeds of operation are tolerable. As stated elsewhere electronic resources may be shared between multiple ones of the EAM drivers thereby reducing the footprint of the chip. The plurality of wavelengths 1012 are combined through a multiplexer 1018 to generate the optical out signal 1002 comprising λ₁, to λₙ in a single stream for onward transmission to the receiver via an appropriate network. There are electrical connections between the electrical input 1006 and each of the EAM drivers 1008. There are optical connections between e.g. passive waveguide materials 1020 between the EAMs 1014 and the multiplexer 1018. There may be an N-to-N relationship between the EAM drivers and the EAMs and with the EAMs and the number of channels in the multiplexer.

Where possible electronics used for active devices may be shared. Passive devices such as the demultiplexer, multiplexer and passive waveguides need no such electronics.

The multiplexer may provide a 5nm optical channel separation in an example. The device 1000 has a structure in which the multiplexer and EAM drivers are parallel to the underlying supporting semi insulated substrate. EAM to multiplexer to fiber out is in the same direction or plane (X, Y) of propagation of the optical beam and provides a unique optical EAM multiplexer monolithic design. As a result, the overall device size in a direction Z (up and down into the figure) is only limited by the size of the EAM driver dimensions. The main factor relating to the size of the EAM drivers is based on the necessary control and driver circuitry and as a result any possibility to avoid duplication in respect of this circuitry has advantages in terms of the overall dimensions of the receiver or transmitter. As stated elsewhere, the dimension can be reduced further by sharing the electronic control and driver components between EAMs and between different components.

A further consequence of EAM to multiplexer to fiber out being in the same direction or plane is that the dimensions of the multiplexer can be minimized as compared to a surface illuminated multiplexer as has been used in alternative concepts. Surface illumination requires a relatively large device to ensure adequate capture of the light. By compression “fiber in” via a cable is already compacted into a relatively small diameter and thus requires a smaller input window for the multiplexer than surface illumination requires.

As stated above, the multiplexer is similarly based on an AI inverse design process having as inputs a definition of the required optical response of the multiplexer which is passed through a model trained on multiplexers and their respective optical requirements including the material from which they are made. The output from the model is a set of design parameters for one of geometry parameters of the multiplexer, a pixelated or QR type code-like structure which sets out a simple dot-based structure, or a full topological structure that meets the required optical response inputs.

In the case of either the demultiplexer and the multiplexer irrespective of the output the model can be used to generate the device layout of the demultiplexer and the multiplexer which is then used in the receiver and transmitter respectively as described below.

The EAMs are similar to WG-pins used in the demultiplexer in the opposite sense.

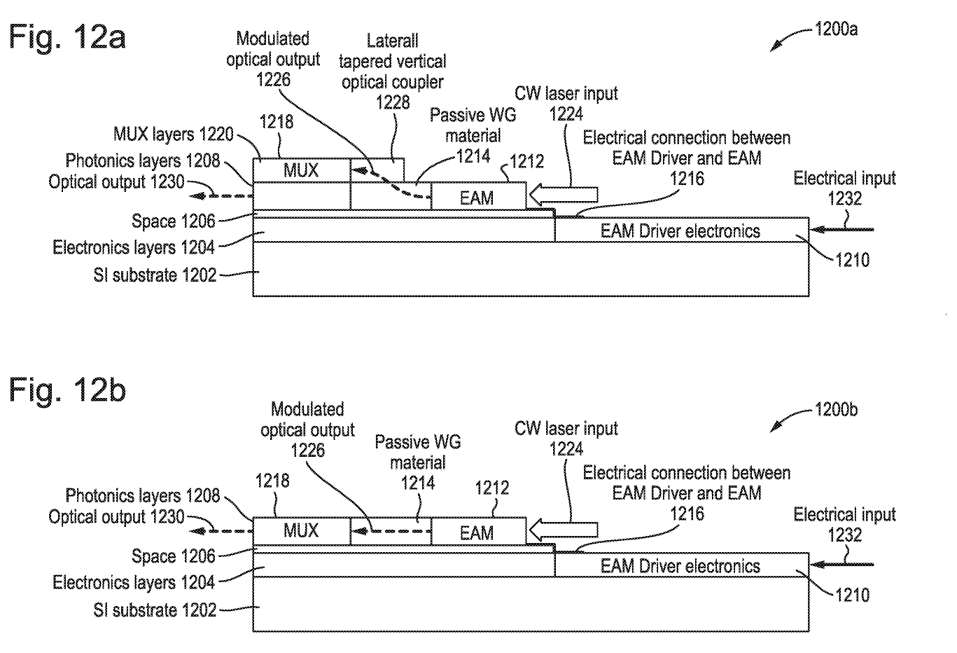

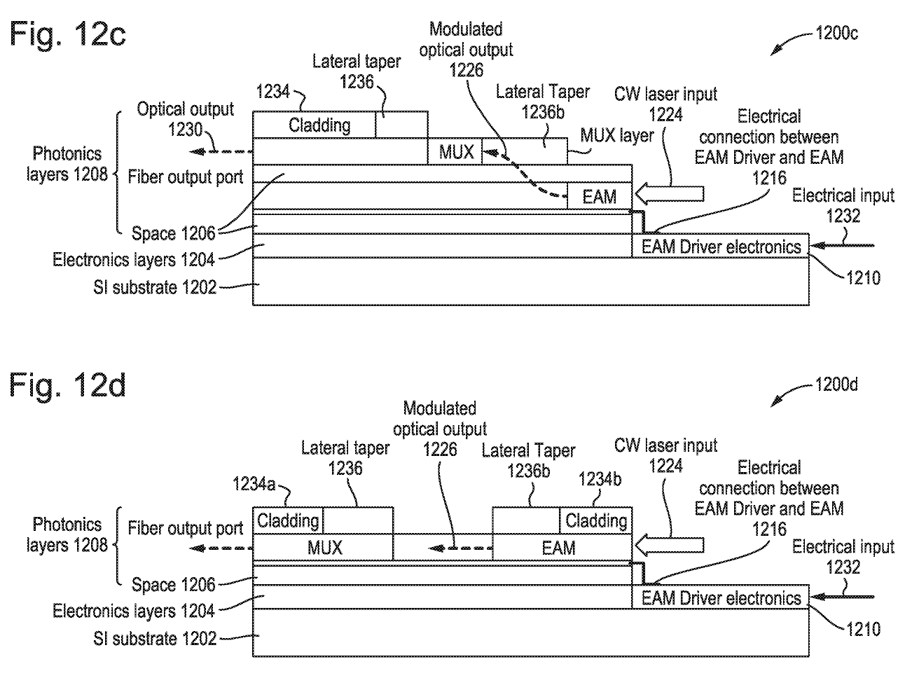

In order to make the combination of devices for either the transmitter or the receiver a fabrication process is required. FIGS. 11 and 12 show an example of a possible epitaxial (epi)-layer structures for a monolithic receiver with demultiplexer as shown in FIG. 9 and a transmitter with a multiplexer as shown in FIG. 10.

FIGS. 11a and 11b both show a simplified cross-sectional view of an epitaxial structure for a monolithically integrated optical receiver including a longitudinal cross-section through one WG-pin PD of a vertical optical coupling of a DEMUX and WG-pin PD according to an aspect of the present application with FIG. 11a being a version with additional cladding/taper features and FIG. 11b being a version without additional cladding/taper features.

FIGS. 11c and 11d both show a simplified cross-sectional view of an epitaxial structure for a monolithically integrated optical receiver including a longitudinal cross-section through one WG-pin PD of a lateral optical coupling of DEMUX and WG-pin PD according to an aspect of the present application with FIG. 11c being a version with additional cladding/taper features and FIG. 11d being a version without additional cladding/taper features.

Like reference numbers in FIGS. 11a-11d relate to the same features and not all reference numbers are repeated in all figures.

Referring to FIG. 11a, a cross-sectional view is shown of an epitaxial structure for a monolithic multidevice receiver device according to an aspect of the present application. This shows a monolithically integrated PIN-TIA-demultiplexer chip 1100 comprising a semi-insulating (SI) substrate 1102, to illustrate monolithic integration of first epitaxial layers for a InP heterojunction bipolar transistor (HBT) 1104 forming the TIA 1105 and horizontally distanced by a spacer layer 1106 from second epitaxial layers 1108 forming a InGaAs WG-pin PD 1110. Layer 1104 or another layer (not shown) may include electronics for driving and controlling each monolithic element of the combined PIN-TIA-demultiplexer. The remainder of layer 1108 includes other photonics as required to operate the WG-pin PD 1110. A conductive trace 1112 connects the WG-pin PD 1110 to the TIA 1105. The conductive trace is formed from one or more metallization layers. A demultiplexer 1114 is formed in a demultiplexer layers 1116 from third epitaxial layers. The demultiplexer layers 1116 are horizontally distanced from the first and second layers. The demultiplexer is configured to receive fiber in 1118 via an input fiber coupling port 1120 from a network (not shown in FIG. 11a) that has been transmitted from a transmitter that may or may not be as described with reference to FIGS. 10 and 12.

The demultiplexer communicates with the WG-pin PD via a laterally tapered vertical optical coupler 1122 and waveguide 1124 passing through the demultiplexer layer 1116. The tapered vertical optical coupler 1122 enables vertical optical communication between horizontally distanced layers. Vertical optical coupling using laterally tapered vertical optical couplers requires appropriate selection of bandgap wavelength and refractive index as will be known to the skilled person. A spacer layer 1106 isolates the first and second epitaxial layers. Other spacer layers may be added as needed to avoid accidental connections and crosstalk between components or devices. An optional cladding layer 1126 is formed atop the demultiplexer along with an optional second laterally tapered vertical optical coupler 1128 to allow light from the fiber into the demultiplexer as an alternative to the waveguide 1124 passing through the demultiplexer layer 1116. The cladding layer 1126 is to facilitate optical coupling to the fiber and to adds an additional and optional layer to the structure. Through the monolithically integrated PIN-TIA-demultiplexer, fiber in 1118 is converted to an electrical output 1132 for delivery to individual customer or users.

The optional cladding layer 1126 and the second laterally tapered vertical optical coupler 1128 are used to couple the fiber and the demultiplexer due to the differences in size between the structures. The fiber is typically ~250µm is diameter and the demultiplexer is considerably smaller. Different diameters of fiber are available and are expected to continue to be smaller in the future. The combination of the optional cladding layer 1126 and the second laterally tapered vertical optical coupler 1128 act as a spot-size converter between the fiber and the demultiplexer. It is possible that different optical components may provide spot-size conversion and may not be required in some examples as shown in some figures.

FIG. 11b is the same device 1100b as in FIG. 11a without the cladding layer 1126 and second laterally tapered vertical optical coupler 1128. This reduces the number of layers and thus the size relative to the FIG. 11a example. Device 1100b otherwise is essentially the same as device 1100a.

Each device formed from epitaxial layers may comprise electronic driving and control circuits which may be formed in further epitaxial layers or those already indicated above for the electronics. These are not shown in detail in FIG. 11 but may be included in the fabrication of the receiver 1100 or may comprise separate components that are later connected to the monolithic receiver 1100.

FIG. 11c shows an alternative example of the monolithically integrated PIN-TIA-demultiplexer chip 1100b. In this example the demultiplexer 1116 is formed in the same photonics layers 1108b as the WG-pin PD 1110. This gives rise to a smaller device in profile and requires an addition passive waveguide material 1130 between the demultiplexer 1116 and the WG-pin PD 1110. The cladding layer 1126 and second laterally tapered vertical optical coupler 1128 are not shown in FIG. 11c. FIG. 11d shows a configuration including the cladding layer 1126 and second laterally tapered vertical optical coupler 1128 to facilitate optical coupling to the fiber. .

FIGS. 11a to 11d shown variations of a monolithically integrated PIN-TIA-demultiplexer chip 1100 and it will be appreciated that other options are available. Not shown in detail in this FIGS. 11a to 11d, but in accordance with other figures there are multiple WG-pin PDs 1110 and TIAs 1105. These are aligned with one another into the page i.e. in the XY plane as shown in FIG. 9. The number of WG-pin PDs 1110 and TIAs 1105 may be equal to one another and match with the number of channels in the demultiplexer. For example, eight or sixteen. As mentioned elsewhere the numbers of WG-pin PDs 1110 and TIAs 1105 may be unequal in applications where high speed of operation are not critical.

FIGS. 12a and 12c are both a simplified cross-sectional view of an epitaxial structure for a monolithically integrated optical transmitter including a longitudinal cross-section through one EAM of a vertical optical coupling of MUX and EAM according to an aspect of the present application with FIG. 12a being a version without additional cladding/taper features and FIG. 12c being a version with additional cladding/taper features.

FIGS. 12b and 12d are both a simplified cross-sectional view of an epitaxial structure for a monolithically integrated optical receiver including a longitudinal cross-section through one EAM of a lateral optical coupling of MUX and EAM according to an aspect of the present application with FIG. 12b being a version without additional cladding/taper features and FIG. 12d being a version with additional cladding/taper features.

FIG. 12a is a cross-sectional view of an epitaxial structure for a monolithic multidevice transmitter 1200 according to an aspect of the present application. This shows a monolithically integrated EAM driver-EAM-multiplexer chip 1200 comprising a semi-insulated substrate 1202 and a monolithic integration of a first plurality of epitaxial layers 1204 forming an EAM driver 1210 and horizontally distanced from a second plurality of epitaxial layers for photonics 1208 forming an InGaAs modulating EAM 1212. The first plurality of epitaxial layers 1204 is separated from the second plurality of epitaxial layers 1208 by a spacer 1206. Layer 1204 or another layer may include electronics for driving and controlling each monolithic element of the combined EAM driver-EAM-multiplexer. The remainder of layer 1208 includes a passive waveguide material 1214. Conductive traces 1216 connect the EAM driver to the EAM. The conductive trace is formed from one or more metallization layers. A multiplexer 1218 is formed from third epitaxial multiplex layers 1220. The multiplexer layers are horizontally distanced from the first and second layers. The EAM receives a continuous wave laser input 1224 to produce a modulated optical output 1226 which passes through a laterally tapered vertical optical coupler 1228 to multiplexer 1218. The multiplexer 1218 is configured to transmit optical out 1230 from the combined optical output from multiple outputs from each EAM. Fiber out 1230 is directed towards a network (not shown in FIG. 12a) for a receiver that may or may not be as described with reference to FIGS. 9 and 11. The multiplexer communicates with the EAM via laterally tapered vertical optical coupler 1228 and passive waveguide material 1214. The taper enables vertical optical communication between horizontally distance layers. Vertical optical coupling using laterally tapered vertical optical couplers requires appropriate selection of bandgap wavelength and refractive index as will be known to the skilled person.

Other spacer layers and isolation layers as previously discussed may be added as needed to avoid unintentional connections and crosstalk between components or devices. Through the monolithically integrated EAM driver-EAM, electrical input 1232 is converted to the optical output 1230 for delivery via the network to receivers wherever they may be.

Each device formed from epitaxial layers may comprise electronic driving and control circuits which may be formed in further epitaxial layers or those already indicated above for the electronics. These are not shown in detail in FIG. 12a but may be included in the fabrication of the transmitter 1200 or may comprise separate components that are later connected to the monolithic receiver 1200.

FIG. 12b shows an alternative example of the monolithically integrated EAM driver-EAM-multiplexer chip 1200b. In this example the demultiplexer 1218 is formed in the same photonics layers 1208 as the EAM 1212. This gives rise to a smaller device in profile and requires passive waveguide material 1214 between the demultiplexer 1218 and the EAM 1212. The EAM receives a continuous wave laser input 1224 to form a modulated optical output 1226 which passes to multiplexer 1218.

FIG. 12c is an equivalent structure to that shown in FIG. 12a and includes a cladding layer 1234 and second laterally tapered vertical optical coupler 1236 to facilitate optical coupling to the fiber. This provides the same function as described elsewhere. FIG. 12d is an equivalent structure to that shown in FIG. 12d and includes first and second cladding layers 1234a and 1234b and additional second laterally tapered vertical optical couplers 1236a and 1236b, one of each over the multiplexer and one over the EAM to facilitate optical coupling to the fiber. This provides the same function as described elsewhere. but may also be applied over a greater surface area to channel light into the multiplexer and to protect from other light sources which may pollute the lateral optical signal.

In FIGS. 11 and 12 the layers are shown by way of example, and it is possible that the different devices of the PIN-TIA-demultiplexer and the EAM driver-EAM-multiplexer may be formed in a different order and be located in different respective layers. The monolithic integration may comprise all optical components and a hybrid integration of electrical components. In the case of hybrid integration of electronic components some devices may be attached later to the monolithic structure in a manner that will be evident to the skilled person. It is noted that each device of the trio of monolithic elements is isolated from the other ones of the trio so that the correct connections are made between the relevant devices. To that end it will be appreciated that different spacer layers, isolation and connections may be made between the devices.

It is also possible that in order to reduce the height of the device in circumstances where this is required there may be multiple devices formed on the same epitaxial layer. This would have a disadvantage that the planar size of the receiver or transmitter may be greater than in the examples disclosed but may be useful in some situations. The use of first, second and third layers is thus only used to distinguish one layer from another and not to indicate a specific order of the layers. Indeed, the first and third layers may actually be the same layers, and the devices thereon are displaced horizontally from the second layer but not from one another.

The demultiplexers and multiplexers may comprise single-stage or multi-stage devices. For example, 2-stage or 3-stage devices as design and use dictates.

Fabrication comprises providing an epitaxial layer structure in which an HBT epi-layer structure is provided on the substrate, with an overlying PIN epi-layer structure. That is the TIA circuitry comprising InP HBTs is fabricated on the SI InP substrate, for high-speed operation of the HBT. The InGaAs PIN is formed by overlying epitaxial layers, separated by a spacer layer, so the optical performance of the photonics devices is not degraded by the underlying conductive layers of TIA circuitry, and the speed and performance of the underlying TIA circuitry can be optimized independently. Also, since the HBT epi-layers of the epitaxial layer stack forming the HBT electronics are distinct from the PIN epi-layers of the epitaxial layer stack forming the PIN, each can be optimized separately. If required a spacer comprising one or more intermediate layers between the HBT epi-layers and the PIN epi-layers may be provided, e.g. to provide electrical isolation, to act as an etch stop to facilitate processing, etc. As illustrated schematically, the area of the TIA circuitry may be isolated from the area of the PIN by a dielectric filled trench. By integration of the HBT electronic circuitry for the TIA and the PIN detector as illustrated schematically, layers of the HBT epi-layer stack and layers of the PIN epi-layer stack may be independently structured and optimized for improved device performance. If required, materials of the epitaxial layer structure may be selected to be compatible with a single epitaxial growth, or alternatively, multiple epitaxial growths may be used, as appropriate. Different processes may be used for fabrication of the HBT epi-layers and PIN epi-layers. For example, in practice, MBE (Molecular Beam Epitaxy) may be used to provide the HBT epi-layers, and MOCVD (Metal Organic Chemical Vapor Deposition) may be used to provide the PIN epi-layers. A semi-insulating spacer may be provided between the HBT epi-layers and the PIN epi-layers. In other embodiments, it is preferred to select an epitaxial layer structure for the HBTs and the PIN which is compatible with single epitaxial layer growth.

In designing the TIA, reducing capacitance allows for a higher transimpedance feedback resistance R_{F,} to increase gain, and the TIA noise is inversely proportional to the feedback resistance R_{F.} It may be beneficial to match the capacitance of the TIA to the device capacitance of the PIN. Since there are a number of parameters that can be adjusted to achieve the required PIN-TIA-DEMUX performance, it may not be necessary to minimize the capacitance of the PIN. With respect to the ground pads of the PIN, it may be beneficial to use multiple pads, e.g. two pads will double capacitance, and halve inductance, e.g. use of multiple wire bonds for the ground pads reduces bond wire inductance (e.g. ~1nH/mm for 25μm bond wires). In designing the PIN, if the responsivity, i.e. A/W, of the PIN is made high enough, so that the SNR in the PIN is higher, the PIN provides a higher input signal to the TIA. This means even if the TIA is noisier (e.g. from lower R_{F}, from higher capacitance) the integrated PIN-TIA-DEMUX will provide improved SNR.

Monolithic integration of an InGaAs PIN using InP HBTs for the TIA provides a solution to a problem that is not easily solvable with silicon photonics comprising normal incidence, e.g. front-entry geometry, Germanium (Ge) PINs.

The monolithic integration approach described herein for reducing parasitic capacitances of the photodiode detector, and then adjusting other parameters of the PIN and TIA to improve quantum efficiency, e.g. to meet sensitivity and responsivity specification for high data rate applications may also be extendible to other types of photodiode detectors, e.g. unitary transit carrier (UTC) photodiode device structures and waveguide PIN geometries, et al.

Monolithic integration of the PIN-TIA-DEMUX eliminates hybrid integration parasitics such as, bond pad capacitances, wirebond resistance/inductance/etc., and direct interconnection of the PIN-TIA-DEMUX provides lower capacitance by eliminating bond pad capacitance, and provides a direct (short-length) lower inductance/lower resistance interconnection. Reduced bond pad capacitance provides associated degrees of freedom to provide improved bandwidth for a PIN of given dimensions and reduced noise. This also provides a very thin, compact demultiplexer.

In another aspect the photonics components DEMUX and multiple WG-PDs may be monolithically integrated on a SI substrate, and the photonics chip hybrid integrated with an electronics chip comprising the plurality of TIAs.

The application in a more general sense can relate to an optical receiver or an optical transmitter. As can be seen from the appended claims and the description there are a number of features in common for both the optical receiver and the optical transmitter. These include the arrangement of epitaxial layers, materials and general functionalities of converting optical signals to electrical signals in one direction (receiving) and in the opposite direction (transmitting) converting electrical signals to optical signals. In broad terms, the application relates to a combination of a waveguide device (a WGPD or EAM); an electronic device (TIA or EAM driver) and a multiplexing device configured to multiplex and/or demultiplex optical channels. These three devices being monolithically integrated on a semi-insulating (SI) substrate and formed from a common substrate as set out in the claims.

### Monolithically integrated PD-TIA of other embodiments

In other embodiments, the design principles disclosed herein for monolithic integration a PIN-TIA-DEMUX comprising an InGaAs PIN and a TIA circuitry fabricated with InP HBTs may be extended to monolithic integration of other types of photodiode with a TIA. Other types of photodiode detectors include, e.g. a Uni-Travelling Carrier (UTC) PD; a waveguide PIN; a resonance enhanced cavity PD; and an APD. To the Applicant’s knowledge, monolithic integration of these types of PD with a TIA is not generally considered. However, to the extent that these device structures can be fabricated to be compatible with HBT technology, e.g. InP HBTs, or HBTs fabricated with other compatible semiconductor materials systems, other options for monolithically integrated PD-TIA with improved performance include the following types of PD:

UTC (uni-travelling carrier) PD. For further bandwidth improvement, a UTC PD design could be used. The benefits of UTC are well-understood. This design is likely to be compatible with HBT technology.

Waveguide pin. A waveguide pin can get as close to 100% responsivity as possible. For ultra-high speed and near-100% responsivity this may need to be accompanied by a traveling wave electrical signal. Traveling wave waveguide pins and modulators are well known in the literature.

Resonance enhanced cavity photodiode (or Resonant cavity enhanced (RCE) PD). This is an interesting option, because the basic idea is to use mirrors to get multiple, not just two, passes through the absorption region for maximum absorption for minimum absorption layer thickness. This device structure also provides a high selectivity of QE vs. wavelength, i.e. one wavelength of absorption is favored. This arrangement would work well for OLT having a well-defined specific wavelength, e.g. 1577nm, or other applications for which the wavelength is well defined. The transit time is quite fast because the absorption layer is thin, and the performance is limited by capacitance. Eliminating bond pad capacitance through monolithic integration with a TIA, presents an attractive route to achieving a minimum, or at least substantially reduced, absorption thickness limit for a given bandwidth, to increase or maximize the advantage of resonant cavity enhancement.

APD. Currently available APDs struggle to get the bandwidth at 10GHz and above. Monolithic integration of an APD and TIA reduces the device capacitance C_{APD} of the APD, allowing, by an argument analogous to that above, a better chance of achieving a required bandwidth. Si APDs are known to be far superior to InP-based APDs in terms of excess noise, because of primarily electron injection into the multiplication region.

Although there are significant improvements to InP-based APDs, the carrier ratio at high gain implies that there is limited gain-bandwidth (GBW) product; further implying the need for additional improvements to make InP APDs practical for ultra-high-speed use. For a monolithically integrated InP APD-TIA, a goal would be to try to reduce the carrier transit time. The transit time is multiplied by two for a SAGCM (Separate Absorption, Grading, Charge and Multiplication) APD, once to get the carriers to the multiplication region, and the other for the multiplied carriers to return to the opposite contact area. In this design, the PD capacitance would be increased, which would not usually be desirable, but this increase in capacitance is compensated for by the reduced capacitance of the monolithically integrated APD-TIA

### Comparison with silicon photonics.

Silicon photonics (SiPho) is well known for integration of a PD with electronic circuitry, e.g. integration of circuitry with a PD that may be a pin PD or APD, waveguide or circular (i.e. normal incidence) geometry. Many of these applications for coherent communications require sufficiently fast PDs (usually pin photodiodes), e.g. for establishing the relative phase for QPSK and higher order QAM, high performance modulation schemes. For applications such as phase comparators, etc., implementing circuitry in silicon technology is straightforward. SiPho tends to use CMOS circuitry, with BJTs, e.g. for pads/macros, but not necessarily HBTs, which have a significant advantage over BJTs for f _{T}, etc. To the Applicants knowledge, very few SiPho applications use a monolithically integrated PD with a TIA, which may be, for example, because effective CMOS circuitry requires smaller geometry (i.e. characterized by shorter transistor gate length) than would be economically effective.

### Optical Line Terminals (OLT) for applications using multiple wavelengths.

For Optical Line Terminals (OLT) for PON or other applications using multiple wavelengths, in particular, there is another reason relating to the PD itself why implementation using SiPho is difficult. 1577nm is close to (or maybe even exceeding) the Ge bandgap energy. Ge is handicapped relative to InGaAs for absorption at this wavelength. It is difficult to achieve good absorption in Ge for a circular i.e. normal incidence geometry PD, whereas for InGaAs this is readily possible. So, although 1577nm stresses the QE vs bandwidth trade-off for InGaAs, this same wavelength makes circular, normal incidence, geometry Ge-based PDs with acceptable QE quite difficult. One would have to resort to a waveguide geometry for the Ge, if the absorption coefficient is high enough for that even to be done (1) without scattering, etc., by the usual imperfections in fabricated waveguides, and (2) to get the traveling wave of the electrical signal well enough matched for what would be a very long waveguide, which for high speed requires traveling wave.

Thus, implementation of a monolithically integrated PIN-TIA-DEMUX with a Ge PD in SiPho presents design and fabrication challenges and presents a “path of high resistance” to practical application. By comparison, monolithic integration of an InGaAs PIN and a TIA fabricated with InP HBTs as described herein, provides a path of “reduced resistance” to practical application, e.g. for OLT and ONU operating at 1.270μm or 1.577μm. Other absorption materials within the InGaAlAsP quintenary system, lattice matched to InP can be used, but of all these, InGaAs lattice matched to InP has the lowest bandgap energy, is direct bandgap, and has the highest absorption coefficient near 1.3μm or 1.5μm, for the OLT and ONU or other typical applications at these wavelengths.

### Industrial Applicability

Disclosed herein are optical receivers of embodiments comprising monolithically integrated components comprising a demultiplexer (DEMUX), a plurality of waveguide photodiodes (WG-PD) and a plurality of transimpedance amplifiers (TIA). Each TIA comprises InP heterojunction bipolar transistors (HBT) fabricated from a first plurality of layers of an epitaxial layer stack grown on a SI: InP substrate; each WG-PD is fabricated from a second plurality of layers of the epitaxial layer stack, overlying the first plurality of layers. The DEMUX is fabricated from photonics layers of the epitaxial stack which may be the same as the second plurality of semiconductor layers of the WG-PD, or additional layers of the epitaxial layer stack. Accordingly, outputs of the DEMUX may be laterally optically coupled through optical waveguide material or outputs of the DEMUX may be vertically coupled to each WG-PD through laterally tapered vertical optical couplers. This design approach enables cost-effective fabrication of a monolithically integrated DEMUX with multiple PIN-TIAs for DWM applications. Also disclosed in an optical transmitter wherein a plurality of electro-absorption modulators (EAM), EAM Drivers, and a Multiplexer (MUX) are monolithically integrated for WDM applications, using similar design principles and fabrication techniques for lateral or vertical optical coupling of outputs of multiple EAMs to the monolithically integrated MUX.

In aspects of the application, it is envisaged that there is an improved performance of optical receivers and transmitters thereby providing a solution to integrating multiple devices on a single chip for applications such as CWDM for high-speed data interconnect, 5G network communications, et al.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an application as defined in the appended claims.

1. A photonic device for receiving an input and providing an output, the photonic device comprising:
an electronic circuitry comprising at least one electronic device;
an optical waveguide device; and
an optical multiplexing device configured to provide one of multiplexing and demultiplexing of optical channels;
wherein the electronic device, the optical waveguide device and the optical multiplexing device are monolithically integrated on a semi-insulating (SI) substrate and comprise an epitaxial layer stack including a first plurality of semiconductor layers and a second plurality of semiconductor layers; and
the at least one electronic device is formed by the first plurality of semiconductor layers of the epitaxial layer stack;
the waveguide device comprises a p-i-n (PIN) device formed by the second plurality of semiconductor layers of the epitaxial layer stack, the second plurality of semiconductor layers comprising an n-layer, an i-layer and a p-layer, and
the optical multiplexing device formed from the second plurality of semiconductor layers and positioned apart from the optical waveguide device and the at least one electronic device, the optical multiplexing device having one or more optical input ports and a one or more optical output ports;
wherein the optical multiplexing device, the waveguide device and the at least one electronic device are configured to receive the input and provide the output.

2. The photonic device of claim 1, comprising a photonic receiver for receiving an optical input and providing an electrical output; the at least one electronic device
comprising a transimpedance amplifier (TIA); the waveguide device comprising a waveguide photodiode (WG-PD), and the optical multiplexing device comprising a demultiplexer,
wherein the TIA, the optical waveguide photodiode and the demultiplexer are monolithically integrated on the SI substrate and comprise the epitaxial stack including the first plurality of semiconductor layers and the second plurality of semiconductor layers;
the TIA is formed by the first plurality of semiconductor layers of the epitaxial layer stack;
the WG-PD comprises the p-i-n (PIN) device formed by the second plurality of semiconductor layers of the epitaxial layer stack, and
the demultiplexer is formed from the second plurality of semiconductor layers and positioned apart from the optical waveguide device and the electronic device, the demultiplexer having an optical input port and a plurality of optical output ports;
wherein the WG-PD is configured to output a photocurrent to the TIA, the TIA configured to provide said electrical output; and
wherein the demultiplexer is configured to receive the optical input, and provide an optical output to each of the plurality of optical output ports, and an input of the WG-PD is optically coupled with one of the plurality of optical output ports of the demultiplexer.

3. The photonic device of claim 2, wherein the receiver comprises a plurality of WG-PDs and a plurality of TIAs, each of the plurality of WG-PDs being optically coupled to a respective one of the plurality of optical output ports of the demultiplexer.

4. The photonic device of claim 2, wherein the receiver comprises a plurality of TIAs and a plurality of WG-PDs in a one-to-one relationship.

5. The photonic device of claim 2, wherein the demultiplexer has N-channels and there are N WG-PDs and N TIAs.

6. The photonic device of claim 2, wherein the i-layer is selected from one of:
a) materials of a group comprising InGaAs;
b) other absorption materials within a InGaAIAsP penternary system; and
c) a multi-quantum well Quantum Confined Stark Effect (MQW QCSE) structure.

7. The photonic device of claim 1, comprising an optical transmitter for transmitting an optical output from an electrical input, wherein the at least one electronic device comprising an electro-absorption modulator (EAM) driver, the waveguide device comprising an EAM and the optical multiplexing device comprising a multiplexer;
wherein the EAM driver, the EAM and the multiplexer are monolithically integrated on the SI substrate and comprise the epitaxial layer stack including the first plurality of semiconductor layers and the second plurality of semiconductor layers;
the EAM driver is formed by the first plurality of semiconductor layers of the epitaxial layer stack;
the EAM is formed by the second plurality of semiconductor layers of the epitaxial layer stack, and
the multiplexer is formed from the second plurality of semiconductor layers and positioned apart from the EAM driver and the EAM, the multiplexer having a plurality of optical input ports and an optical output port;
wherein the EAM driver is configured to output a photocurrent to the EAM, the EAM driver configured to receive said electrical input; and
wherein the multiplexer is configured to receive a plurality of optical inputs on each of the plurality of optical input ports, and provide an optical output to the optical output port, and an output of the EAM is optically coupled with one of the plurality of optical input ports of the multiplexer.

8. The photonic device of claim 7, wherein the transmitter comprises a plurality of EAMs and a plurality of EAM drivers, each of the plurality of EAMs being optically coupled to a respective one of the plurality of optical output ports of the multiplexer.

9. The photonic device of claim 7, wherein the transmitter comprises a plurality of EAM drivers and a plurality of EAMs in a one-to-one relationship.

10. The photonic device of claim 7, wherein the multiplexer has N-channels and there are N EAMs and N EAM drivers.

11. The photonic device of claim 1, wherein the second plurality of semiconductor layers are photonics layers.

12. The photonic device of claim 1, wherein the first plurality of semiconductor layers are electronics layers.

13. The photonic device of claim 1, wherein the second plurality of semiconductor
layers comprise a first set semiconductor layers and a second set of semiconductor layers and wherein the waveguide device is formed by the first set semiconductor layers and the optical multiplexing device is formed by the second set of semiconductor layers.

14. The photonic device of claim 13, wherein the optical multiplexing device communicates with the waveguide device via an optical connection between the waveguide device and the optical multiplexing device.

15. The photonic device of claim 14, further comprising one or more optical connections the or each of which comprises a laterally tapered vertical optical coupler.

16. The photonic device of claim 1, wherein the optical multiplexing device is designed via an AI-based inverse design process.

17. The photonic device of claim 1, wherein the optical multiplexing device is designed via an AI-based inverse design process trained on one or more of an AI model, an optimizer and a simulator; and configured to have inputs that determine one or more optical characteristics of the optical multiplexing device.

18. The photonic device of claim 17, wherein the AI-based inverse design process produces an output that meet the inputs wherein the output comprises one or more of an empirical structural detail including geometry parameters of the optical multiplexing device, a pixelated structure, a voxelated structure or a QR type code-like structure which sets out a simple dot-based structure of the optical multiplexing device, or a full topological structure of the optical multiplexing device.

19. The photonic device of claim 1, wherein the electronic circuity comprises one or more InP heterojunction bipolar transistors (HBTs).

20. The photonic device of claim 1, wherein the SI substrate comprises a SI Indium Phosphide (InP) substrate.

21. The photonic device of claim 1, fabricated with an InP-based materials system comprising binary, ternary, quaternary and other compositions of In, Ga, As, Al, P and Sb.

22. An optical system including the photonic device according to claim 1.

23. An optical system including the photonic device according to claim 2.

24. An optical system according to claim 23 and comprising more than one photonic device.

25. A photonic device comprising a demultiplexer (DEMUX) and an array of a plurality of waveguide photodiodes (WG-PD) monolithically integrated on a semi-insulating (SI) substrate, comprising:
an epitaxial layer stack comprising a plurality of semiconductor layers formed on the SI substrate structured to form optical waveguides of the DEMUX and the plurality of WG-PDs;
the DEMUX comprising a first part of the plurality of semiconductor layers, and comprising an optical input port for receiving a multiplexed input optical signal, and a plurality of optical outputs for outputting a plurality of demultiplexed optical signals;
the array of the plurality of WG-PDs comprising a second part of the plurality of semiconductor layers, the second part being horizontally distanced from the first part, and the plurality of WG-PDs being arranged in parallel; and
an input of each WG-PD is optically coupled with one of the plurality of optical outputs of the DEMUX, and each WG-PD is configured to output a photocurrent to an electrical output.

26. The device of claim 25, wherein the DEMUX has N-channels and the array comprises N WG-PDs.

27. The device of claim 25, wherein the input of each WG-PD is optically coupled with one of the plurality of optical outputs of the DEMUX via an optical connection between the WG-PD and the DEMUX.

28. The device of claim 27, wherein optical axes of waveguides of the DEMUX and the array of WG-PDs are coplanar, and the optical connection comprises a laterally coupled optical waveguide.

29. The device of claim 25, wherein the DEMUX is designed via an AI-based inverse design process.

30. A photonic device comprising a multiplexer (MUX) and an array of a plurality of electro-absorption modulators (EAM) monolithically integrated on a semi-insulating (SI)substrate, comprising:
an epitaxial layer stack comprising a plurality of semiconductor layers formed on the SI substrate structured to form optical waveguides of the MUX and the plurality of EAMs;
the MUX comprising a first part of the plurality of semiconductor layers, and comprising and a plurality of optical inputs for receiving a plurality of optical signals and an optical output port for outputting a multiplexed output optical signal;
the array of the plurality of EAMs comprising a second part of the plurality of semiconductor layers, the second part being horizontally distanced from the first part, and the plurality of EAMs being arranged in parallel; and
each EAM is configured to receive a continuous wave optical input and an EAM drive signal and to output a modulated optical output, and the modulated optical output of each EAM is optically coupled with one of the plurality of optical inputs of the MUX.
